(19) United States
(12) Patent Application Publication
(10) Pub. No.: US 2001/0056377 A1
(43) Pub. Date: Dec. 27, 2001

(54) CYBER MALL SYSTEM

(76) Inventors: KAORI KONDOH, YAMATO-SHI (JP); TETSUYA MASUISHI, MACHIDA-SHI (JP); HIROSHI KOIKE, SAGAMIHARA-SHI (JP); RIE KOBAYASHI, TOKYO (JP); SATOSHI TAKEUCHI, YOKOHAMA-SHI (JP); AKIRA MATOIKE, YOKOHAMA-SHI (JP); JUN NITTA, YOKOHAMA-SHI (JP)

Correspondence Address: MATTINGLY, STANGER & MALUR, P.C., 104 EAST HUME AVENUE, ALEXANDRIA, VA, 22301, US

(21) Appl. No.: 08/871,964

(22) Filed: Jun. 10, 1997

(30) Foreign Application Priority Data
Jun. 13, 1996 (JP) 08-152099

(51) Int. Cl. G06F 17/60

(52) U.S. Cl. 705/26

(57) ABSTRACT

A cyber shop client defines cyber shop definition information by a shop layout defining unit, an electronic shopping cart electronic form defining unit, and a goods registering unit. A cyber mall server generates cyber shop information on the basis of the cyber shop definition information from the cyber client by a shop layout registering unit, an electronic shopping cart electronic form registering unit, and a goods storing unit. Further, the cyber mall server generates display information from the cyber shop information composed of a shop management database, a shop layout database, an electronic shopping cart electronic form database, an electronic shopping cart database, and a goods database by a parameter analyzing unit, a file retrieving unit, and a display data generating unit.

### BACKGROUND OF THE INVENTION

The invention relates to a set-up of shops and a shopping method in a cyber mall on the Internet called a shopping mall. More particularly, the invention relates to a cyber mall developing and managing method suitable for a change in layout of shops and a management of shops in which a replacement of goods is frequently performed.

The following article has been disclosed at page 1 of Nikkei Sangyo Simbun of Oct. 24, 1994.

“NTT Data Communication Co., Ltd. developed a multimedia system “Virtual Mall” (Cyber Mall) in which the user circulates a virtual street drawn by computer graphics (CG) and can enjoy an on-line shopping. The user can select a shop and purchase as if he walked a street on a personal computer, two-way television, or the like at home. There is a plan such that a purchasing method is constructed in a form near an actual shopping of the user, even a person who is inexperienced in a computer can easily operate, and an advertisement by a signboard and a sound or the like is also fetched. If such a system is spread all over the country, there is also a possibility such that a style of a marketing industry such as department store, specialty store, or the like remarkably changes.”

The following article has been disclosed in the paper about information, communication, and multimedia of Nikkei Sangyo Shimbun of Mar. 1, 1996.

“Fujitsu Limited opens a cyber mall on the Internet from March. Software made by Netscape Communications Co. Ltd. of U.S.A. is introduced, thereby enabling an on-line settlement using a credit card to be performed. Although Fujitsu Limited has provided so far a management and a retrieval service of a gallery in which pictures are collected on the Internet, it calculates upon a double effect with a connecting service or the like by adding a shopping function.”

As mentioned above, the shopping system using the Internet started its operation.

The following three styles are considered as patterns of electronic commerce by the Internet.

(1) A shop uniquely connects to the Internet and the selling shop directly installs a WWW server and directly provides goods information and orders from the users. A work such as a reservation of seats or the like in which stocks have to be updated in a real-time manner needs to be managed in such a style.

(2) A WWW server which is unique to the indirect selling by the shop and the mall is not provided and goods information is provided by the mall. The order information from the user can be received to the shop system in a real-time manner. The management in such a style is considered in a general enterprise.

(3) Goods information is provided and the order from the user is received by an agency selling mall server by the mall. The received order information is separately connected to the shop. A management in such a style is suitable in small, middle, and personal enterprises.

When shops are managed, each system has merits and demerits.

According to the style (1), there is an advantage such that a change in price of goods or the like can be performed in a real-time manner. However, a long time and much expenses are required for management of the server. It is difficult to manage the shop in terms of the costs unless it is a very big shop.

The style (2) needs a device to seemlessly interconnecting a request from the customer between the mall server and the shop system.

The style (3) cannot promptly cope with a change request of goods information or the like from a shop.

To set up a shop in a shopping mall at present, a system of an agency selling by a mall is the main current because of the following two points.

(1) The shop can be set up with low costs.

(2) The shop can be set up by only a specialist of business (person having no special knowledge about the computer).

As a patent regarding the cyber shopping, there is the invention “Article retrieving method and apparatus” (JP-A-8-22498) regarding an article retrieving method in a cyber mall. The above invention has an object to realize a system in which a purchasing activity of human being is simulated as it is and has the following construction: a file to store cyber world video images of shops or the like; a file to store actual photographed video images of a goods exhibition in each shop; a file to store detailed information of each item of goods; and a processing unit for displaying the cyber world video images to a display unit. A cyber world to be displayed changes in accordance with an operation input from an input unit. When the operator enters a certain shop in the cyber world, the processing unit reads out the goods exhibition video image in the relevant shop from the file and displays to the display unit. The goods exhibition video image to be displayed also changes in accordance with the operation input. When the operator designates desired goods on the goods exhibition video image, the processing unit reads out the detailed information from the file and displays.

To set up a shop in the shopping mall, the user forms a home page on the Internet by using HTML (Hypertext Markup Language). In recent years, there is a tool for converting wordprocessor software into the HTML format or an authoring tool as means for forming a home page.

It is necessary to always notify the customer of latest goods information. When observing the actual shop, a layout, kinds, and the like of the goods in the shop are always changed. The goods which will be sold in that day are arranged at places where they are conspicuous to the customer's eyes and the other goods are put at places which are inconspicuous or the like. However, in the present shopping mall, the mall manager manages all information of shop and goods and there is a problem such that even if a change occurs in the handling goods on the shop side, it takes a time to change them. Even if the goods enter an available state in which they can be sold, unless the goods are presented to the customer, nobody can purchase them. In order to efficiently manage the shop in the agency selling system by the mall, it is necessary to promptly reflect a willing of the shop manager as shop information or goods information. The invention disclosed in JP-A-8-22498 relates to the method of presenting goods and nothing is mentioned about the above point.

In case of forming a virtual product catalog by using the authoring tool, each time an addition or deletion of goods is performed, it is necessary to add or delete the home page and it is also necessary to change a definition of a link relation of the concerning page. Further, the goods information has also been registered in a goods DB on the mall•server and it is also necessary to add or delete the goods DB on the server. Therefore, it is difficult for the shop person who has no special knowledge about the computer to perform a maintenance of the virtual product catalog by using the authoring tool.

### SUMMARY OF THE INVENTION

In a managing method of an agency selling by a cyber mall, it is an object of the invention to provide a cyber mall system for setting up a cyber shop by a method which can promptly cope with a change or addition of shop information or goods information.

In the agency selling system by the mall, in order to promptly cope with the change or addition of shop information or goods information, the invention provides a frame work which can add or update shop information by a plug-in system. That is, the following means are provided in order to realize a frame work such that information of shops and goods is stored to the mall server side and the shop side can operate at a remote location as necessary.

(1) Means for instructing the addition or updating of shop information or goods information on the shop side.

(2) Means for registering information of shops or goods on the mall server side.

(3) Means for forming the information of shops or goods registered in the mall by the HTML format when there is a display request.

In the means (1), it is necessary that a specialist of a business can freely edit a home page.

The shop manager defines shop information corresponding to the layout of the virtual product catalog and goods information of goods which are actually arranged. The shop information is formed by combining parts on an editor which is provided by the invention. The goods information is registered from a panel for registering goods.

When the information defined by the shop manager is transferred to the mall server, mall information forming means is activated. The shop information is registered into a shop layout DB. The goods information is registered into a goods DB.

When there is a display request of the shop information, a mall information conversion is activated. The relevant shop information is retrieved with reference to the shop layout DB. Further, the relevant goods information is retrieved with reference to the goods DB. An HTML to display the shop information and goods information is formed and transferred to a requesting source.

### BRIEF DESCRIPTION OF THE DRAWINGS

FIG. 1 shows a whole construction of a present system;

FIG. 2 shows a transition example of change of the panel of the system;

FIG. 3 is a flowchart for the fundamental operation in the Internet;

FIG. 4 shows a mall background panel;

FIG. 5 shows shop name information;

FIG. 6 shows a display panel of a list of panels;

FIG. 7 shows an electronic form of a cyber shopping cart;

FIG. 8 shows a layout of a panel;

FIG. 9 shows a display example of a shopping catalog;

FIG. 10 shows an example data of goods background panel data;

FIG. 11 shows an example of a composition of goods background panel data and goods information;

FIG. 12 shows a goods DB; and

FIG. 13 shows a goods information registration panel.

### DESCRIPTION OF THE PREFERRED EMBODIMENTS

An embodiment of the invention will now be described hereinbelow with reference to the drawings.

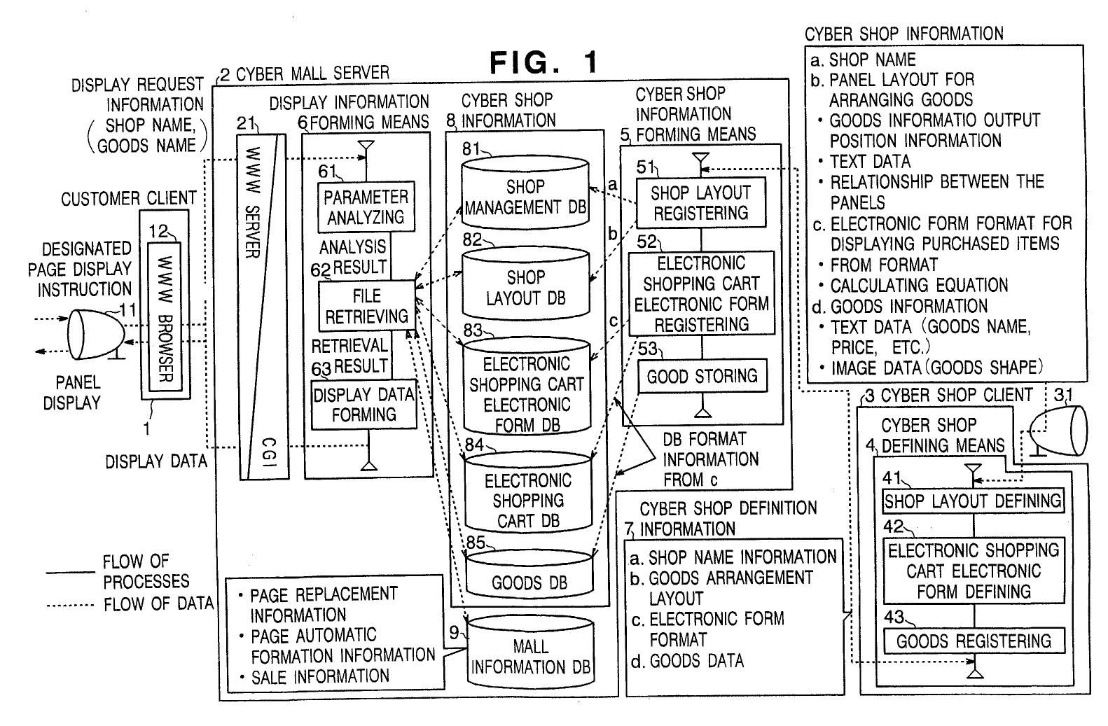

FIG. 1 shows a construction of the invention.

A cyber mall system is made up of a customer client 1, a mall server 2, and a cyber shop client 3. They are interconnected by a network. The customer client 1 has an input/output device 11. The cyber shop client 3 has an input/output device 31. In the cyber shop client 3, cyber shop definition information 7 is defined by means 4 for defining a cyber shop through the input/output device 31. The cyber shop definition information 7 is information regarding shops and goods to be arranged in the shops. The cyber shop defining means 4 is made up of shop layout defining means 41, electronic shopping cart electronic form defining means 42, and goods registering means 43.

In the mall server 2, means 5 for forming cyber shop information 8 forms the cyber shop information 8 on the basis of the cyber shop definition information 7. The means 5 for forming the cyber shop information 8 is made up of shop layout registering means 51, electronic shopping cart electronic form registering means 52, and goods storing means 53. The cyber shop information 8 is composed of a shop management DB 81, a shop layout DB 82, an electronic shopping cart electronic form DB 83, an electronic shopping cart DB 84, and a goods DB 85. That is, the cyber shop information 8 is information that is necessary for the customer to purchase goods on a cyber mall and the cyber shop definition information 7 is also included therein.

The shop layout defining means 41 defines a shop layout to display goods information as cyber shop information 8 to the customer. The defined information is stored into the cyber shop information 8 through the shop layout registering means 51. Particularly, layout information indicative of a layout in the cyber shop is stored into the shop layout DB 82. Information which is necessary for the mall server to manage each of a plurality of cyber shops in a form of mall is stored in the shop management DB 81.

The electronic shopping cart electronic form defining means 42 defines a display format of an electronic shopping cart to display a list of goods selected by the customer as an electronic form (electronic shopping cart electronic form). The defined information is stored in the electronic shopping cart electronic form DB 83 through the electronic shopping cart electronic form registering means 52 as data storage information to the electronic shopping cart DB 84 in order to store an electronic form format, a calculating equation, and information regarding the goods selected by the customer. The electronic shopping cart DB 84 is formed on the basis of the item information formed from the electronic form format.

The goods registering means 43 registers prices, shapes, and the like of goods to be sold in the cyber shop as goods information. The registered information is stored into the goods DB 85 through the goods registering means 53.

In the cyber mall of the invention, the addition, change, or deletion of not only the individual goods but also the cyber shop itself can be performed by the cyber shop definition information 7.

In the customer client 1, when a display of the cyber shop information 8 is instructed from the input/output device 11, means 6 for forming display information from the cyber shop information 8 is activated through a World Wide Web (hereinafter, abbreviated to WWW) browser 12 and a WWW server•CGI (Common Gateway Interface: application program interface) 21 of the mall server 2. The means 6 for forming the display information from the cyber shop information 8 forms the display information to the customer client 1 with reference to the cyber shop information 8. The means 6 for forming the display information from the cyber shop information 8 is made up of parameter analyzing means 61, file retrieving means 62, and display data forming means 63.

A mall information DB 9 stores panel information and a program to manage the mall, customer information, and the like.

The parameter analyzing means 61 analyzes parameters including a request for purchasing goods inputted from the customer client and display request page information.

The file retrieving means 62 retrieves the shop management DB 81, shop layout DB 82, electronic shopping cart electronic form DB 83, electronic shopping cart DB 84, goods DB 85, or mall information DB 9 on the basis of an analysis result of the parameter analyzing means 61.

The display data forming means 63 is a WWW page generator for forming data which can be displayed as a WWW page on the basis of a retrieval result of the file retrieving means 62.

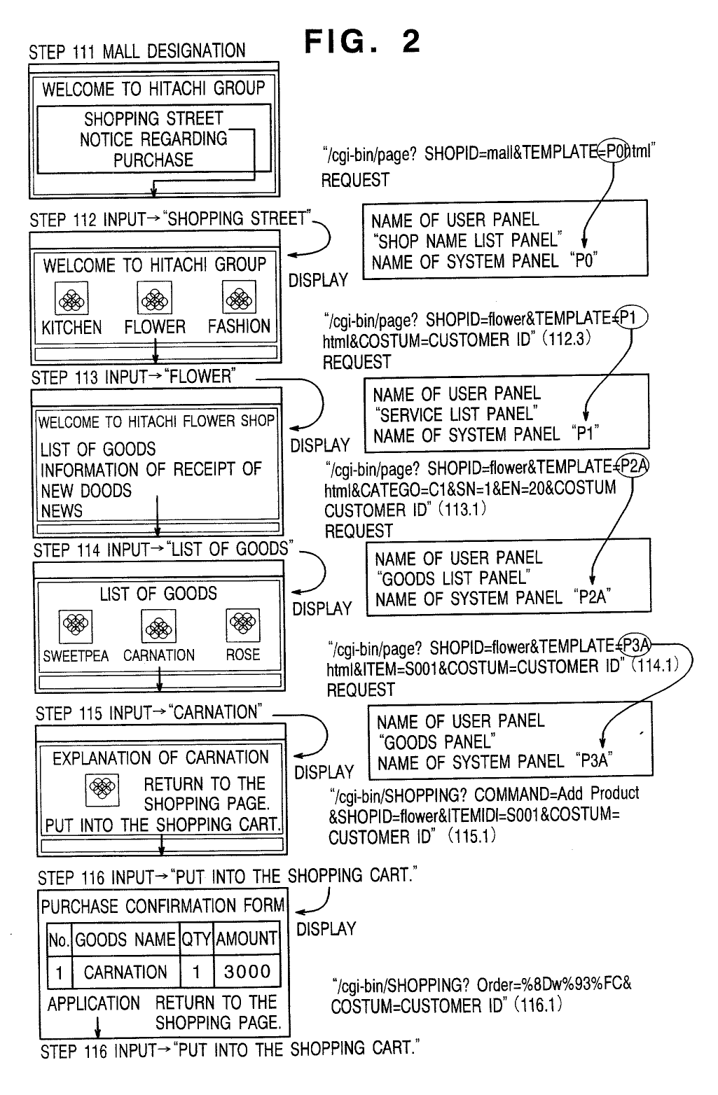

FIG. 2 shows the operation of the input/output device 11 in the customer client 1 in case of purchasing “carnation” in “flower” of the “Hitachi group” mall by using the cyber mall system. A text shown on the right side of FIG. 2 is internal data which is formed in association with an input from the input/output device 11 and its details will be explained hereinlater.

Step 111: The customer designates Uniform Resource Locator (hereinafter, abbreviated to URL) of the mall on a client personal computer which can be physically connected to the Internet.

Step 112: “shopping street” is selected on a mall entrance panel.

Step 113: A target shop name “flower” is selected on a shop name list panel.

Step 114: “list of goods” is selected on a service list panel.

Step 115: “carnation” is selected on a goods list panel.

Step 116: “put into cart” is selected on a goods display panel.

Step 117: When the customer instructs “application” on the display panel of the shopping•electronic shopping cart to display a list of goods in a state selected at present by the customer, a process for purchasing (a mail is sent to the mall via an electronic mail or the like) is executed. The panel is returned to a mall entrance panel or a shop name list by an instruction of the operator. The processing routine is also returned to step 112 or 113.

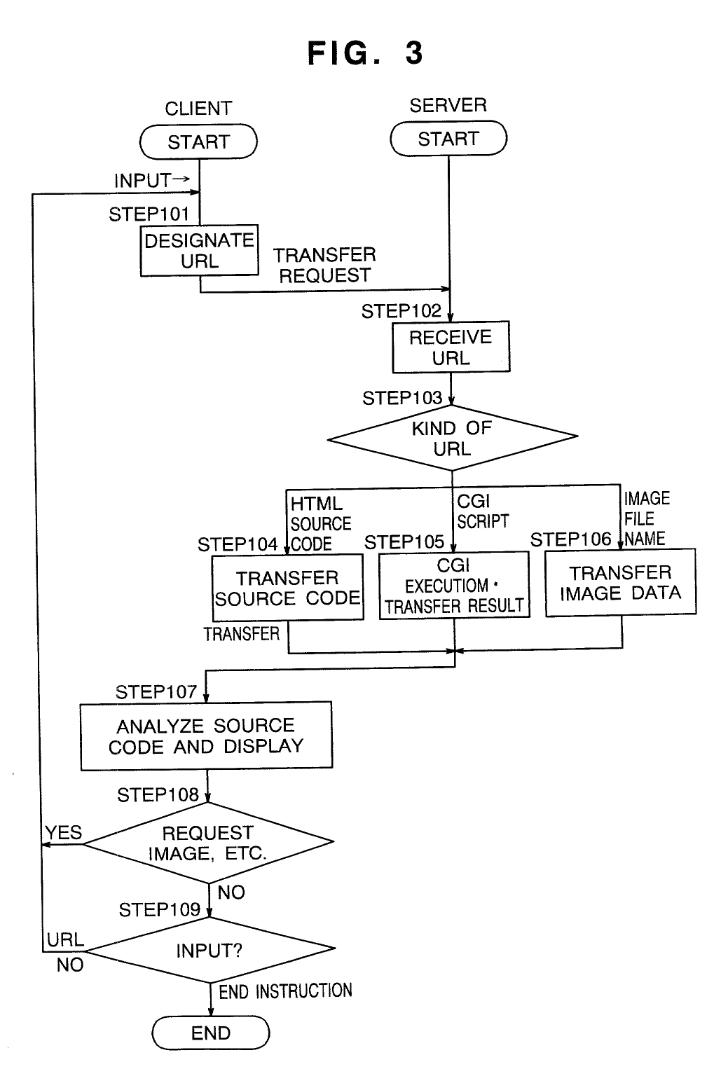

Prior to describing the process which is executed in response to the above operation, with respect to the relation between a client machine and a server machine in the Internet, the fundamental operation will now be described with reference to a flowchart of FIG. 3.

### Step 101: (client machine)

A WWW browser, such as Netscape, Navigator, or the like is activated on the client personal computer which can be physically connected to the Internet. A URL (for example, WWW/hitachi mall. co. jp) indicative of an address of a desired home address is designated. The client personal computer requests the server machine having the URL to transfer information.

### Step 102: (server machine side)

A transfer request is received from the client machine.

### Step 103: (server machine side)

The URL can designate not only the address of the home page but also a CGI script and a file name to store image data. A check is made to see if the transferred URL is any one of the address of the home page, CGI script, and file name to store the image data.

### Step 104: (server machine side)

When the transferred URL is the address, a source code (HTML source code) of the home page is transferred to the client machine.

### Step 105: (server machine side)

When the transferred URL is the CGI script, the CGI script is executed and its result is transferred to the client machine.

### Step 106: (server machine side)

When the transferred source code is the file name of the image data, the image data is transferred to the client machine.

### Step 107: (client machine)

The transferred source code is analyzed and a portion which can be displayed is displayed.

### Step 108: (client machine)

When the image data or the file name of the CGI script has been described, the processing routine advances to step 101.

### Step 109: (client machine)

The system waits for an input of the operator. What is called an anchor tag indicative of a link destination of the page is included in a source code. The operator clicks a character train, image data, or region designated in the anchor tag on the panel by using a mouse, the URL can be designated. When the URL is newly designated, step 101 follows. In the above fundamental operation, the operation of the CGI script in step 105 is a feature of the invention.

A grammar for the operation of the CGI script in the embodiment will now be described.

### EXAMPLE 1

### Display of Panel

/cgi-bin/page?SHOPID=home&TEMPLATE=P1.htm1&COSTUM=customerID” (211.1)

A P1.htm1 panel of a shop of “home” is displayed and the customer who is operating is shown.

page: indicates the CGI to form a catalog.

SHOPID: ID to specify the shop.

TEMPLATE: catalog template. Specifies the kind of background panel.

COSTUM: ID to specify the customer.

### EXAMPLE 2

### One Goods is Displayed

/cgi-bin/page?SHOPID=home&TEMPLATE=P1.htm1&ITEM=S001&COSTUM=customerID” (211.2)

ITEM: Goods ID of the goods to be displayed.

### EXAMPLE 3

### A Predetermined Number of Goods are Displayed

/cgi-bin/page?SHOPID=home&TEMPLATE=P1.htm1&ITEM1=S-001&ITEM2=S-002&COSTUM=customerID” (211.3)

In a shop home, goods S-001 and S-002 are displayed on the P1.htm1 panel.

ITEM: Goods ID of the goods to be displayed. A plurality of IDs can be set.

### EXAMPLE 4

### Goods of a Designated Number or Less are Displayed

/cgi-bin/page?SHOPID=home&TEMPLATE=P1.htm1&CATEGO=C1&SN=1&EN=20&COSTUM=customerID” (211.4)

In the shop home, when there are 20 or more goods on a goods shelf C1, 20 goods are displayed on the P1.htm1 panel and when there are 19 or less goods, all of the goods are displayed there.

CATEGO: A category (goods shaft name) is designated.

SN: Starting goods (designated by the display order number).

EN: The number of goods displayed

The operation in each panel in FIG. 2 will be specifically explained.

When the customer instructs a display of the shopping street in step 112, the shop name list panel is displayed.

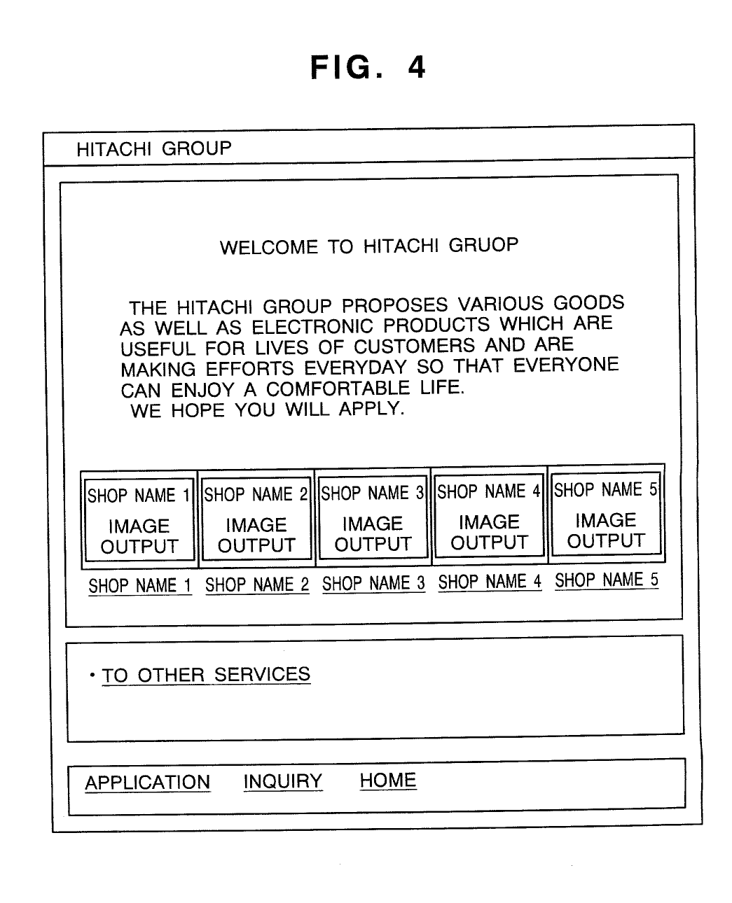

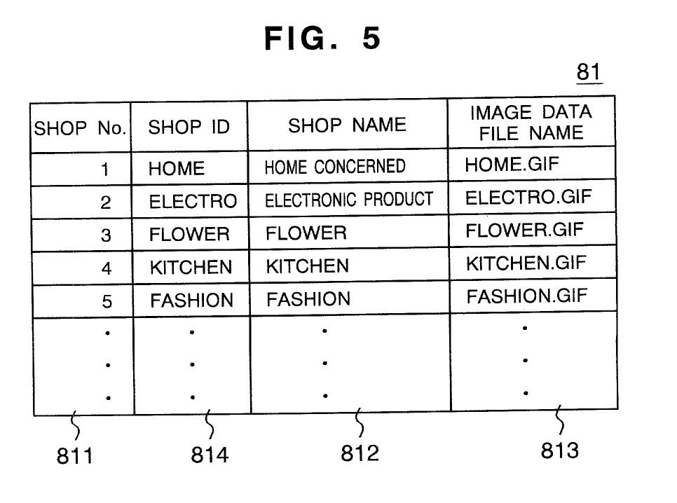

A display process of the shop name list panel will now be described. The shop name list panel is a picture in which shop name information (FIG. 5) of the opening shop to be stored in the shop management DB 81 is compounded to a mall background panel (FIG. 4) stored in the mall information DB 9. The shop name list panel is displayed on the input/output device 11 of the customer client 1, thereby setting the screen into a state in which the customer can select the shop where he intends to purchase the goods through the input/output device 11.

Text data or image data such as a logo or the like can be also used as shop name information. The mall background panel data is described by HTML and stored into the mall information DB 9. The shop name information is stored into the shop management DB 81 by text data 812 or a file name 813 to store the image data and a shop ID 814. The shop management DB 81 also stores a shop No. 811. The shop name list panel information is formed by the following steps.

Parameter analysis 61:

URL“/cgi-bin/page?SHOPID=mall&TEMPLATE=P0.htm1”

is analyzed and a process to form the shop name list panel by “SHOPID=mall” is started.

File retrieval 62: The mall background panel data (P0.htm1) is retrieved from mall information DB 9 and the shop name information is retrieved from the shop management DB 81, respectively.

Display data formation 63: The mall background panel data and the shop name information are compounded and an HTML source code of the shop name list panel is formed.

A part (anchor portion) of the HTML source code of the shop name list panel is shown below.

<A HREF=“/cgi-bin/page?SHOPID=home&TEMPLATE=P1.htm1&COSTUM=customerID”>home concerned</A> (112.1)

<A HREF=“/cgi-bin/page?SHOPID=electro&TEMPLATE=P1.htm1&COSTUM=customerID”>electronic products</A> (112.2)

<A HREF=“/cgi-bin/page?SHOPID=flower&TEMPLATE=P1.htm1&COSTUM=customerID”>flower</A> (112.3)

<A HREF=“/cgi-bin/page?SHOPID=kitchen&TEMPLATE=P1.htm1&COSTUM=customerID”>kitchen</A> (112.4)

<A HREF=“/cgi-bin/page?SHOPID=fashion&TEMPLATE=P1.htm1&COSTUM=customerID”>fashion</A> (112.5)

The customer ID is allocated when entering the panel (for example, Hitachi group mall) in FIG. 4 and is valid only for a period of time during which the customer purchases in the Hitachi group mall.

In step 113, when the customer selects the shop name “flower” from the shop name list panel displayed, namely, when URL

“/cgi-bin/page?SHOPID=flower&TEMPLATE=P1.htm1&COSTUM=customerID” (112.3)

is selected, the P1 panel (in this case panel service list) of the “flower” shop is displayed.

A display process of the panel of service list will now be described. The panel of service list is a P1 picture of the shop name “flower” stored in the shop layout DB 82 and is displayed on the input/output device 11 of the customer client 1 and shows a state in which the customer can select a service to be received hereinafter through the input/output device 11.

The service list panel information is formed by the following steps.

Parameter analysis 61:

URL“/cgi-bin/page?SHOPID=flower&TEMPLATE=P1.htm1&COSTUM=customerID” (112.3)

is analyzed, the target shop is specified by the parameter “flower”, and a process to form the P1 panel is started by the parameter “P1.htm1”.

File retrieval 62: The P1 panel information of “flower” is retrieved from the shop layout DB 82.

Display data formation 63: The HTML source code of the P1 panel is formed from the shop layout information.

A part (anchor portion) of the HTML source code of the service list panel is shown below.

<A HREF=“/cgi-binpage?SHOPID=flower&TEMPLATE=P2A.htm1&CATEGO=C1&SN=1&EN=20&COSTUM=customerID”>list of goods</A> (113.1)

<A HREF=“/cgi-bin/page?SHOPID=flower&TEMPLATE=P2B.htm1&COSTUM=customerID”>receipt of new goods</A> (113.2)

<A HREF=“/cgi-binpage?SHOPID=flower&TEMPLATE=P2C.htm1&&COSTUM=customerID”>news </A> (113.3)

<A HREF=“/cgi-binpage?SHOPID=flower&TEMPLATE=P2D.htm1&&COSTUM=customerID”>to other services</A> (113.4)

In step 114, when the customer selects “list of goods” from the service list panel displayed, namely, when

URL“/cgi-binpage?SHOPID=flower&TEMPLATE=P2A.htm1&CATEGO=C1&SN=1&EN=20&COSTUM=customer ID” (113.1)

is designated, a P2A panel (in this case panel of goods list) of the “flower” shop is displayed.

A display process of the panel of goods list will now be described. The panel of goods list is a P2A picture of the shop name “flower” stored in the shop layout DB 82 and is a panel obtained by compounding the goods information stored in the goods DB 85 to the goods list background panel. The goods list panel is displayed on the input/output device 11 of the customer client 1 and sets the screen into a state in which the customer can select goods in which he wants to know the details or to purchase through the input/output device 11.

There are the following items in the goods DB 85.

| | |
|---|---|
| Category: | Category name to classify goods. |
| Display order: | Display order on the goods shelf. |
| ITEM: | Code which is used to order goods. |
| Name: | Name of goods. |
| Price: | Price of goods. |
| Specifications: | Specifications of goods. |
| Image: | File name to store the image data |
| | indicative of an external appearance of |
| | the goods. |
| Explanation: | Explanation sentences to introduce |
| | goods. |
| Model No.: | Model No. of the maker of goods. |

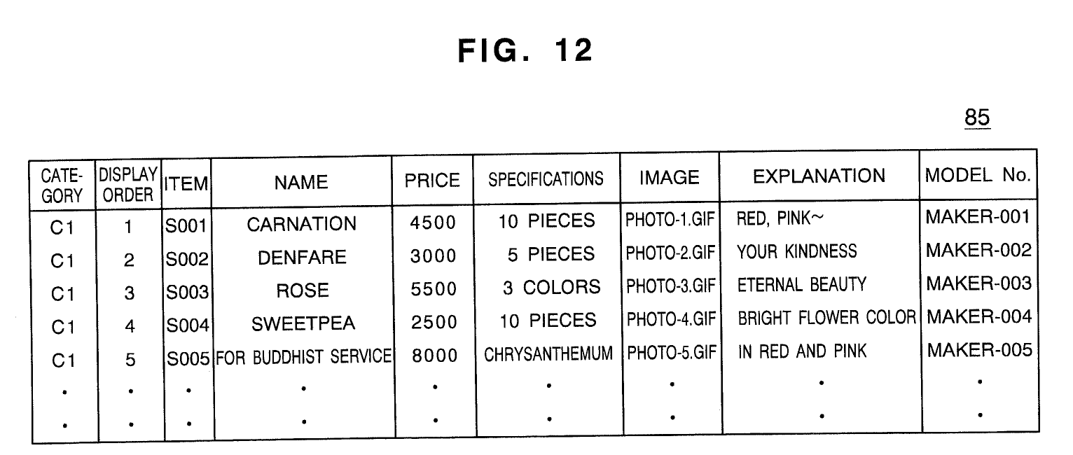

The contents of the goods DB 85 are shown in FIG. 12.

The background panel of goods list is described by HTML and stored into the shop layout DB 82. The goods information is composed of text data, such as a goods code, a goods name, a price, an explanation of goods, goods management information or the like, and image data of goods. The text data and the file name in which the image data has been stored are stored into the goods DB 85.

The panel of goods list information is formed by the following steps.

Parameter analysis 61:

URL“/cgi-binpage?SHOPID=flower&TEMPLATE=P2A.htm1&CATEGO=C1&SN=1&EN=20&COSTUM=customer ID”>(113.1)

is analyzed, the target shop is specified by the parameter “flower”, and a process to form the P2A panel by the parameter “P2A.htm1” is started.

File retrieval 62: The P2A panel information of “flower” is retrieved from the shop layout DB 82 and the goods information regarding the goods of goods Nos. 1 to 20 in the category C1 is retrieved from the goods DB 85, respectively.

Display data formation 63: The shop layout panel data of a retrieval result and the goods information are compounded and an HTML source code of the P2A panel is formed.

A part (anchor portion) of the HTML source code of the panel of goods list is shown.

<A HREF=“/cgi-bin/page?SHOPID=flower&TEMPLATE=P3A.htm1&ITEM=S001&COSTUM=customerID”>carnation</A> (114.1)

<A HREF=“/cgi-bin/page?SHOPID=flower&TEMPLATE=P3A.htm1&ITEM=S002&COSTUM=customerID”>Denfare </A> (114.2)

<A HREF=“/cgi-binpage?SHOPID=flower&TEMPLATE=P3A.htm1&ITEM=S003&COSTUM=customerID”>rose </A> (114.3)

<A HREF=“/cgi-binpage?SHOPID=flower&TEMPLATE=P3A.htm1&ITEM=S004&COSTUM=customerID”>sweet pea</A> (114.4)

<A HREF=“/cgi-binpage?SHOPID=flower&TEMPLATE=P3A.htm1&ITEM=S005&COSTUM=customerID”>for Buddhist service</A> (114.5)

In step 115, when the customer selects “carnation” from the goods list panel displayed, namely, when

URL“/cgi-binpage?SHOPID=flower&TEMPLATE=P3A.htm1&ITEM=S001&COSTUM=customerID” (114.1)

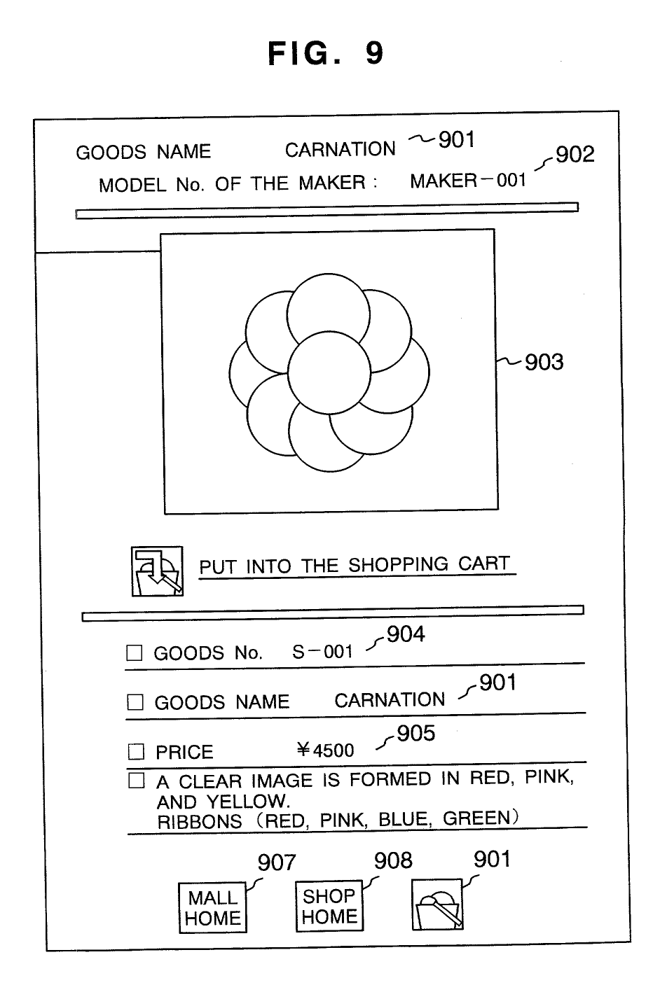

is designated, a P3A panel (in this case panel of goods) of the “flower” shop is displayed (FIG. 9).

A display process of a goods panel will now be described. The panel of goods is a P3A picture of the shop name “flower” stored in the shop layout DB 82 and is a panel obtained by compounding the goods information stored in the goods DB 85 to the background panel of goods. The goods panel is displayed on the input/output device 11 of the customer client 1 and sets the screen into a state in which the customer can select whether he purchases goods through the input/output device 11 or not.

The background panel of goods data is described by HTML and stored into the shop layout DB 82. The goods information is composed of text data such as a goods code, a goods name, a price, an explanation of goods, goods management information or the like, and image data of goods. The goods DB 85 stores the text data and the file name to store the image data.

The panel of goods information is formed by the following steps.

Parameter analysis 61:

URL“/cgi-bin/page?SHOPID=flower&TEMPLATE=P3A.htm1&ITEM=S001&COSTUM=customerID” (114.1)

is analyzed, the target shop is specified by the parameter “flower”, and a process to form a P3A panel by a parameter “P3A.htm1” is started.

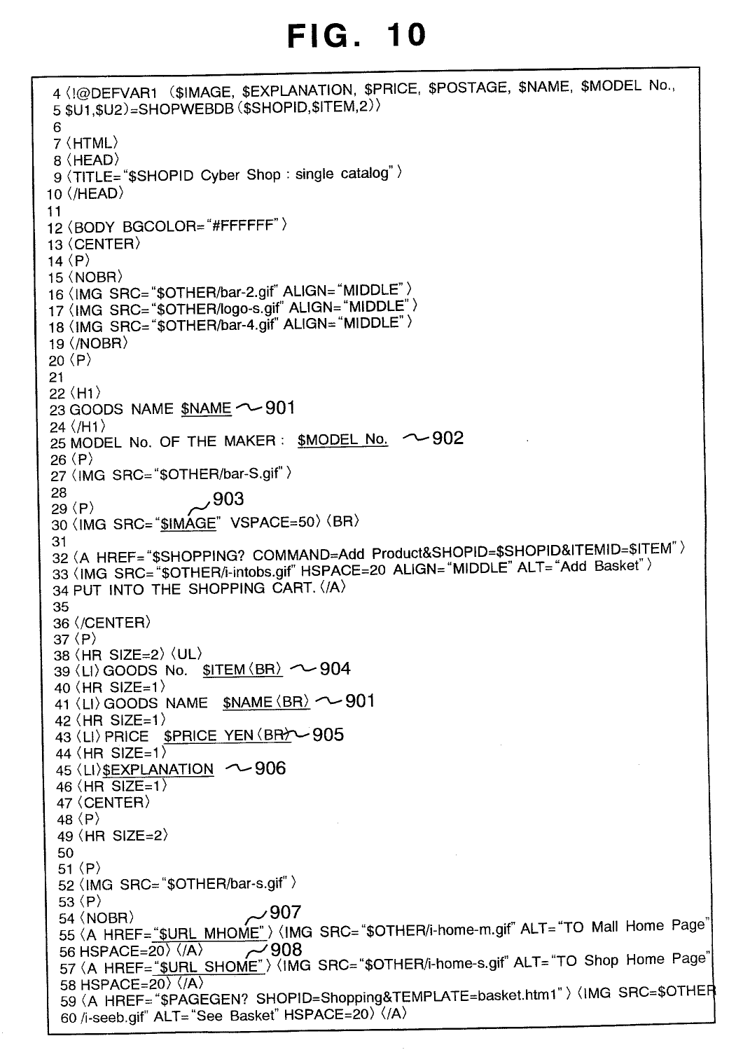

FIG. 10 shows a part of a source list of P3A.htm1.

Line No. 4: Declaration to check the database. $SHOPID sets a value of a parameter SHOPID in the URL and $ITEM sets a parameter ITEM in the URL, respectively.

Line No. 23: A name 901 is retrieved from the goods DB 85 and sets by using a value of $ITEM as a key.

Line No. 25: A model No. 902 is retrieved from the goods DB 85 and sets by using the value of $ITEM as a key.

Line No. 30: A file name 903 to store the image data is retrieved from the goods DB 85 and sets by using the value of $ITEM as a key.

Line No. 39: A value of a parameter ITEM 904 in the URL is set.

Line No. 41: The name 901 is retrieved from the goods DB 85 and sets by using the value of $ITEM as a key.

Line No. 43: A price 905 is retrieved from the goods DB 85 and sets by using the value of $ITEM as a key.

Line No. 45: An explanation 906 is retrieved from the goods DB 85 and sets by using the value of $ITEM as a key.

Line No. 55: A macroprogram 907 to form an URL of the home page of the mall is called.

Line No. 57: A macroprogram 908 to form an URL of the home page of the shop is called.

File retrieval 62: P3A panel information of “flower” is retrieved from the shop layout DB 82 and goods information of a goods S001 to be displayed is retrieved from the goods DB 85.

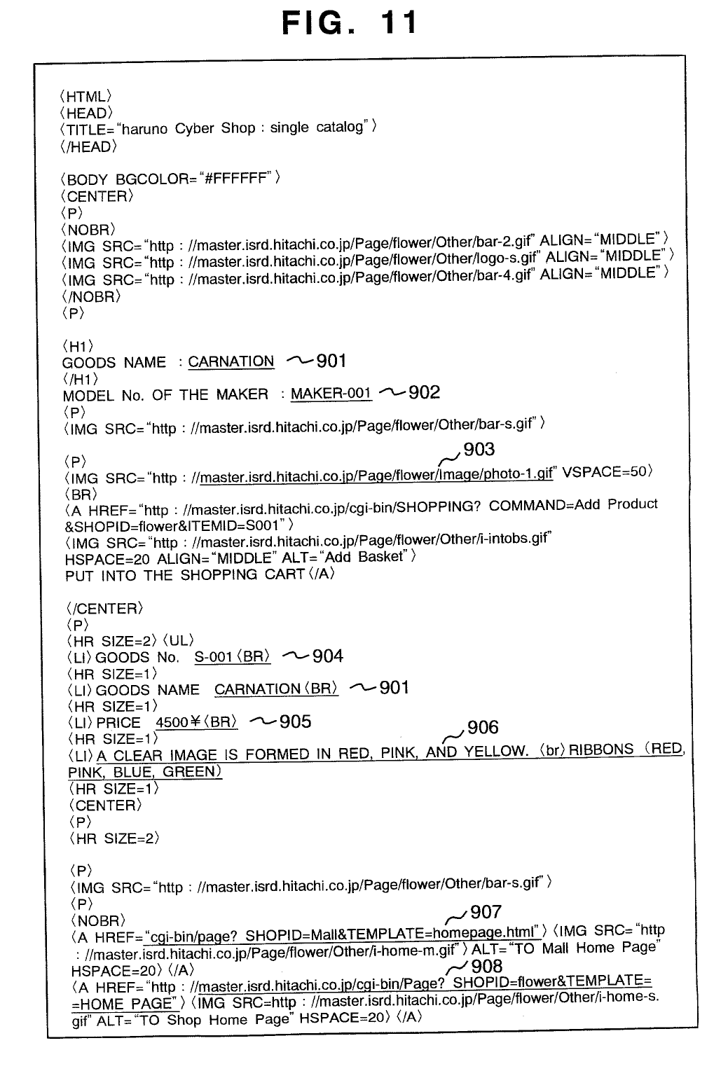

Display data formation 63: The shop layout panel data P3A as a retrieval result and the goods information S001 are compounded and an HTML source code of the P3A panel is formed (FIG. 11).

Data to be set is shown below.

901 name→“carnation”

902 model No.→“MAKER-001”

903 file name→“photo-1.gif”

904 ITEM→“S-001”

905 price→“4500”

906 explanation→“A clear image is produced in red, mink, and yellow. Ribbon (red, pink, blue, green)”

907 URL of home page→“/cgi-bin/page?SHOPID=Mall&TEMPLATE=homepage.htm1”

908 home page of shop→master.isrd.hitachi.co.jp/cgi-bin/Page?SHOPID=flower&TEMPLATE=HOMEPAGE”

A part (anchor portion) of an HTML source code of the panel of goods list is shown.

<A HREF=“/cgi-bin/SHOPPING?COMMAND=AddProduct&SHOPID=flower&ITEMID=S001&COSTUM=customerID”>put into cart</A> (115.1)

In step 116, when the customer instructs a purchase of goods (“put into cart” is selected), namely, when

URL“/cgi-bin/SHOPPING?COMMAND=AddProduct&SHOPID=flower&ITEMID=S001&COSTUM=customerID” (115.1)

is designated, an electronic shopping cart display panel is displayed. The electronic shopping cart DB 84 accumulates the goods in which the purchase is designated. The electronic shopping cart display panel displays the contents of the electronic shopping cart DB 84 to the customer.

An electronic shopping cart display process will now be described. The electronic shopping cart panel is a panel in that the goods information which is stored in the electronic shopping cart DB 84 and in which the purchase is instructed is compounded to the electronic shopping cart panel that is stored into the electronic shopping cart electronic form DB 83. The electronic shopping cart display panel is displayed on the input/output device 11 of the customer client 1 and sets the screen into a state in which the customer can confirm a purchase instructing situation of the goods and can select whether he purchases goods or not through the input/output device 11. The electronic shopping cart electronic form data is described by HTML and stored into the electronic shopping cart electronic form DB 83. The goods name, price, number, and the like of the goods in which the purchase is instructed are stored in the electronic shopping cart DB 84.

The panel of electronic shopping cart display information is formed by the following steps.

Parameter analysis 61:

URL“/cgi-bin/SHOPPING?COMMAND=AddProduct&SHOPID=flower&ITEMID=S001&COSTUM=customerID” (115.1)

is analyzed, the target shop is specified by the parameter “flower”, and the customer is specified by the customer ID. A process to form the panel of electronic shopping cart by a parameter “COMMAND=AddProduct” is started.

File retrieval 62: The electronic shopping cart electronic form information of “flower” is retrieved from the electronic shopping cart electronic form DB 83 and the goods information of the customer ID to be displayed is retrieved from the electronic shopping cart DB 84, respectively.

Display data formation 63: A process AddProduct (CGI script) described in the electronic shopping cart electronic form as a retrieval result is executed. A calculating equation is executed and a process to register the goods information (S001) described in the data storage information to the electronic shopping cart DB and the customer ID into the electronic shopping cart DB 84 is executed. Further, a form format of the electronic shopping cart electronic form and the goods information of the customer ID are compounded and an HTML source code is formed.

A part (anchor portion) of the HTML source code of the panel of electronic shopping cart display is shown.

<A HREF=“/cgi-bin/SHOPPING?Order=%8Dw%93%FC&COSTUM=customerID”>application </A> (116.1)

In step 117, when the customer instructs “application”, that is, when

URL“/cgi-bin/SHOPPING?Order=%8Dw%93% FC&COSTUM=customerID” (116.1)

is designated, a purchasing process is executed. Purchasing processing information has been stored in the mall information DB 9.

The purchasing process is executed by the following steps.

Parameter analysis 61:

URL“/cgi-bin/SHOPPING?Order=%8Dw%93% FC&COSTUM=customerID” (116.1)

is analyzed and the customer is specified by the parameter customer ID. The purchasing process is started by the parameter “Order=% 8 Dw % 93% FC”.

File retrieval 62: Goods information corresponding to the customer ID is retrieved from the electronic shopping cart DB 84 and a purchase processing program is retrieved from the mall information DB 9, respectively.

Display data formation 63: A process (CGI script) described in the purchasing process of a retrieval result is executed and the goods information of the purchased goods is deleted from the electronic shopping cart DB 84.

The purchasing process has been preset in the mall. An application form is displayed on the input/output device 11 of the customer client 2, thereby allowing the customer to input necessary items such as paying method, receiver's address of goods, and the like from the input/output device 11. The inputted information is transmitted to the mall through communicating means. Since processes after the information was received are out of a scope of the invention, they are not described in detail here.

A method for setting up a cyber shop according to the invention will now be described hereinbelow.

As cyber shop information to set up a cyber shop in the mall, the following four items are defined through the input/output device 31 of the cyber shop client 3.

(a) Shop name

(b) Panel of layout for arranging goods

b-1 Text data

b-2 Goods information output position information

b-3 Button

b-4 Relationship between the panels

(c) Electronic form format (electronic shopping cart electronic form) for displaying purchasing items

c-1 Text data

c-2 Form format

c-3 Button

c-4 Calculating equation

(d) Goods information

d-1 Text data (goods name, price, etc.)

d-2 Image data (goods shape)

The details of the definition information of the cyber shop information will now be described every means included in the means 4 for defining the cyber shop.

The shop layout defining means 41 defines (a) the shop name and (b) the panel of layout for arranging goods.

(a) The shop name is registered. In case of displaying the shop name by image data on the panel showing a list of shop names, a name of a file to store the image data is also registered.

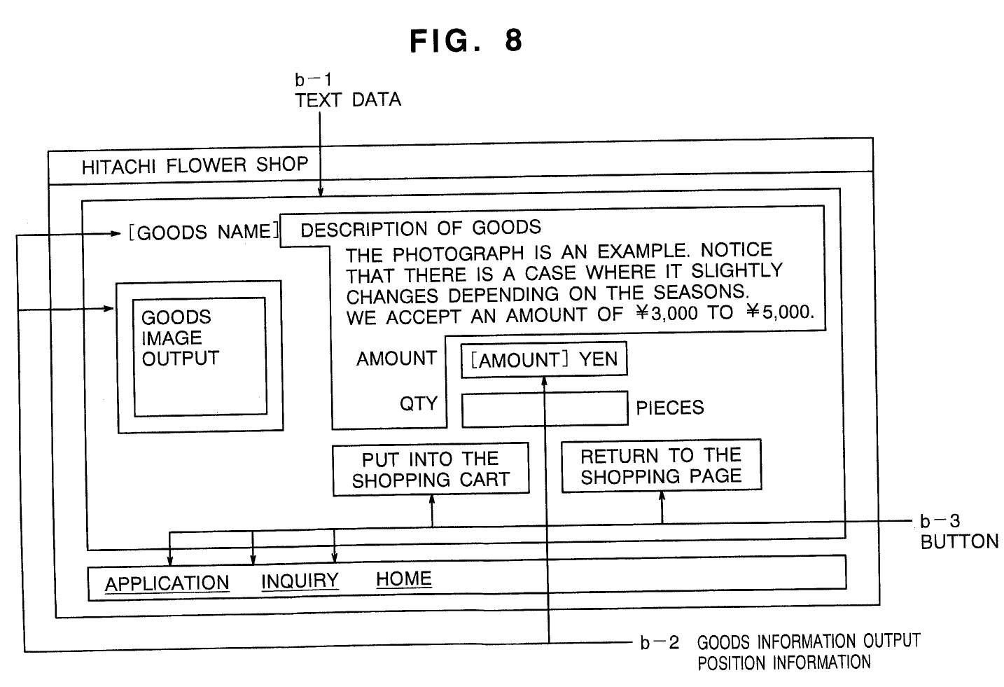

(b) The panel of layout for arranging the goods is information indicating by which panel (the panel of layout shown in FIG. 8) and by which panel transition (relationship between the panels) the customer is allowed to purchase.

The panel layout is composed of the (b-1) text data, (b-2) goods information output position information, and (b-3) button. Although each of the panel names is set by the system, the user can also add a user name to each panel.

The (b-1) text data is defined by the same operation as that of general drawing software by using a keyboard and a mouse.

The (b-2) goods information output position information is information to display information of goods to be stored in the goods DB 85 onto the panel and defines a position and a size of the panel to be displayed. Attribute parts such as goods name, goods code, prices, goods shape image data, and the like prepared for the definition panel are adhered onto the panel by adjusting the display position, size, and the like.

The (b-3) button is prepared as a part such as “return to the mall” or the like to instruct a movement to another panel. The button is adhered onto the panel on the display.

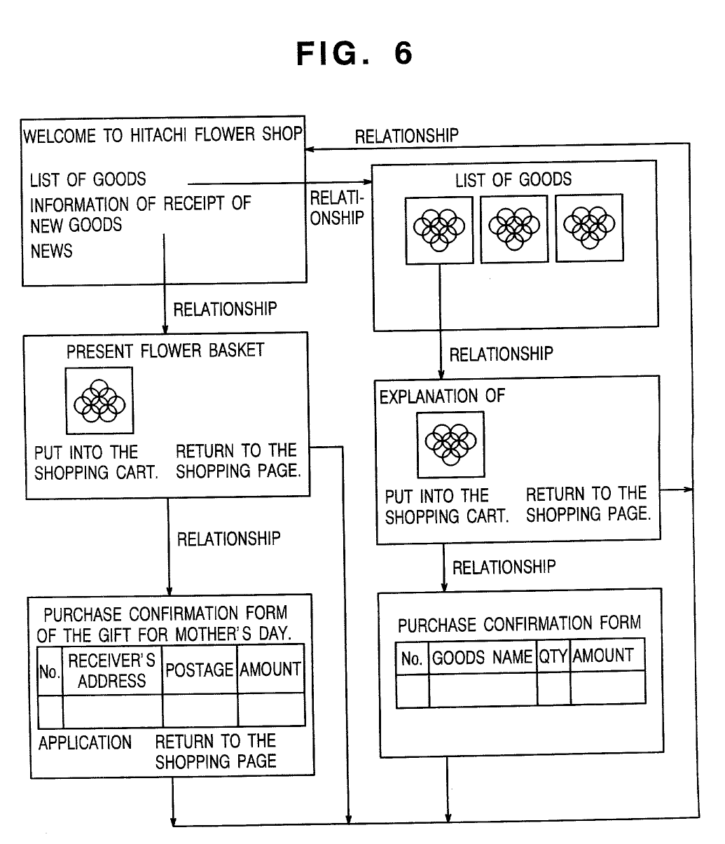

The (b-4) relationship between the panels is defined on the display panel of the list of panel shown in FIG. 6. An addition, new formation, or deletion of a page is also performed on the basis of the relationship between the panels.

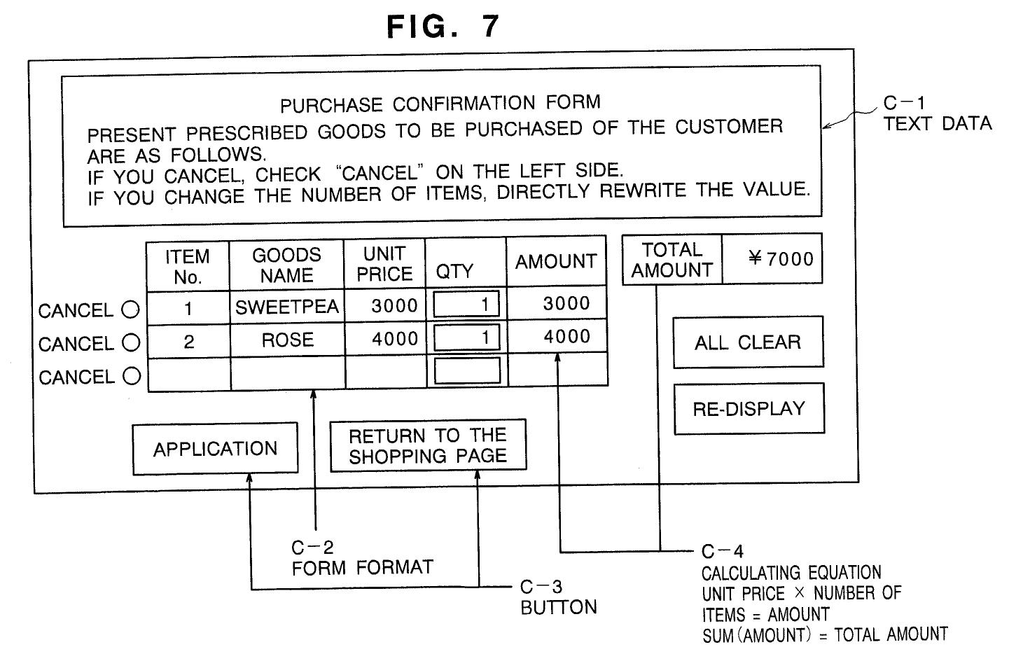

The electronic shopping cart electronic form defining means 42 defines a display format of the electronic shopping cart to display a list of goods selected by the customer as a (c) electronic shopping cart electronic form shown in FIG. 7.

As for an electronic shopping cart electronic form, a plurality of kinds of forms can be set for one cyber shop.

The (c-1) text data and (c-2) form format are defined by the same operation as that of the general drawing software by using the keyboard and mouse.

The (c-3) button is similar to (b-3).

The (c-4) calculating equation is an equation to calculate a money amount of goods purchased and is defined by a numerical equation such as

unit price×number of goods=money amount

SUM (money amount)=total money amount or the like.

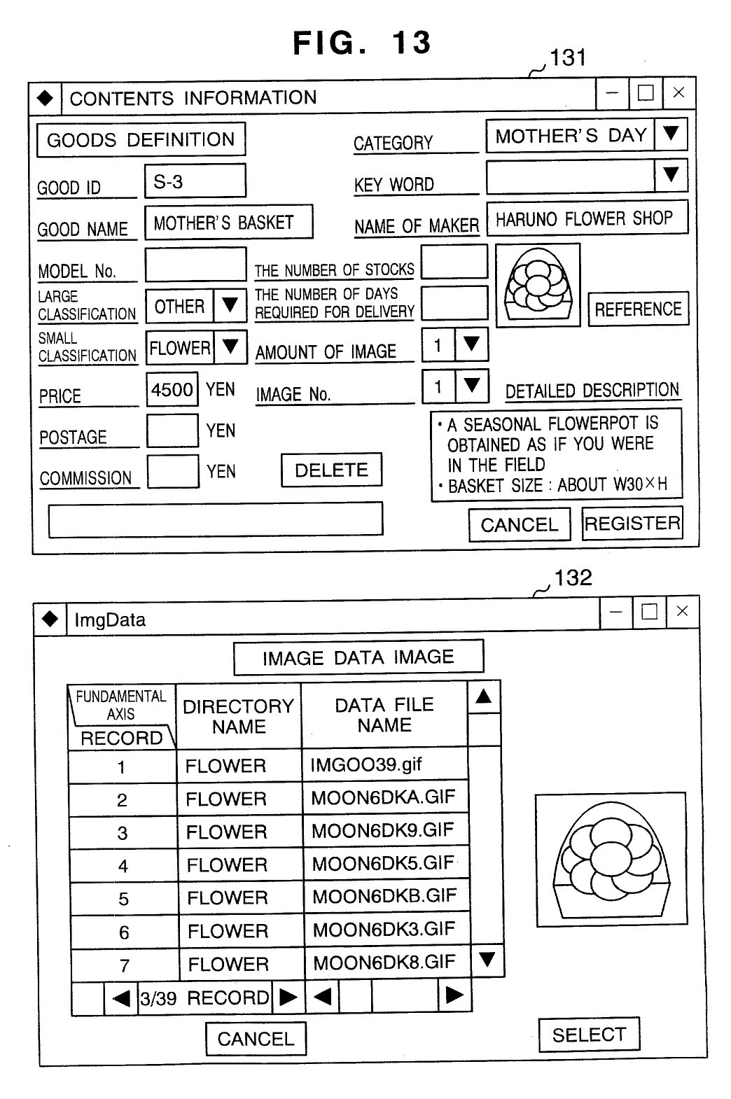

The goods registering means 43 registers the price and shape of the goods to be sold in the cyber shop as (d) goods information into the goods DB 85 by a registration panel as shown in FIG. 13.

Registration 131 of the (d-1) text data

A goods name, a goods code, a price, a size, a color, an explanatory sentence, etc. are registered.

Registration 132 of the (d-2) image data

A name of file to store a photograph or an illustration of the goods is registered.

The above cyber shop information is sent as cyber shop definition information 7 to the mall server 2.

In the mall server 2, the means 5 for forming the cyber shop information 8 forms the cyber shop information 8 by the following processes with reference to the cyber shop definition information 7.

(a) The shop layout registering means 51 registers the shop name 812 as shop name information into the shop management DB 81 shown in FIG. 5. When the name of the file to store the image data is defined, the file name 813 is also registered. The shop No. 811 is data which is set on the mall server 2 side.

(b) The panel of layout for arranging the goods is stored into the shop layout DB 82. Information of an anchor tag indicative of a link destination of a page is formed from the display definition information of the goods name or goods shape image data in the (b-2) goods information output position information. On the basis of the (b-4) relationship between the panels, one information of the anchor tag is formed with respect to one relation information.

The electronic shopping cart electronic form registering means 52 forms item information from the (c-2) form format. The item information is composed of an item name, a data attribute, and a data length. The electronic shopping cart DB 84 in which the item information formed and the customer ID are set to items is formed. Further, data storage information to the electronic shopping cart DB is formed as information to store data into the electronic shopping cart DB 84. The data storage information formed is stored into the electronic shopping cart electronic form DB 83 together with the (c-1) text data, (c-2) form format, (c-3) button, and (c-4) calculating equation.

The goods storing means 53 stores the (d) goods information into the goods DB 85.

The above processes relate to the step of forming the cyber shop information 8.

By storing sale information composed of sale performing condition information and sale performing contents information into the mall information DB 9, the price of the goods can be discounted when the sale information satisfies predetermined conditions.

In steps 115 and 116 in FIG. 2, the mall information DB 9 is also retrieved at the time of the file retrieval 62 and the presence or absence of the sale performing condition information. When it satisfies the sale performing conditions, the price of the goods displayed by the HTML source code which is formed at the time of the display data formation 63 is calculated in accordance with the sale performing contents information and the calculated price is displayed.

According to the invention, by providing a frame work in which shop information can be added or updated by a plug-in system, the shop manager of the cyber shop can define the shop information and goods information. Therefore, in the agency selling system by the mall, the shop information and goods information can be promptly changed or added.

By separating the goods information and the panel of layout information, the work to add or delete the goods can be performed without considering the preceding and subsequent relation of the panel.

What is claimed is:

1. A cyber mall system for performing an agency selling of goods through a network, comprising:
a cyber shop client for defining cyber shop definition information regarding a shop and goods to be arranged in said shop; and
a cyber mall server for forming cyber shop information to purchase the goods on the basis of said cyber shop definition information transferred from said cyber shop client through said network and for forming display information to order the goods from said cyber shop information in accordance with a request transferred from a customer client through said network.

2. An agency selling method of goods by a cyber shop client for selling goods and a cyber mall server to which a customer client who purchases the goods is connected through a network, comprising the steps of:
a) defining cyber shop definition information regarding a shop and goods to be arranged in said shop on the basis of an input from said cyber shop client;
b) forming cyber shop information to purchase the goods on the basis of said cyber shop definition information; and
c) forming display information to order the goods from said cyber shop information in accordance with a request from said customer client.

3. A storage medium in which a program to execute an agency selling method of goods by a cyber shop client who sells goods and a cyber mall server to which a customer client who purchases the goods is connected through a network has been stored and which can be read by a computer, wherein said agency selling method comprises the steps of:
a) defining cyber shop definition information regarding a shop and goods to be arranged in said shop on the basis of an input from said cyber shop client;
b) forming cyber shop information to purchase the goods on the basis of said cyber shop definition information; and
c) forming display information to order the goods from said cyber shop information in accordance with a request from said customer client.

4. A cyber mall system for performing an agency selling of goods through a network, comprising:
a cyber shop client having cyber shop defining means for defining cyber shop definition information regarding a shop and goods to be arranged in said shop; and
a cyber mall server having cyber shop information forming means for forming cyber shop information to purchase the goods on the basis of said cyber shop definition information transferred from said cyber shop client through said network and display information forming means for forming display information to order the goods from said cyber shop information in accordance with a request transferred from a customer client through said network.

5. A system according to claim 4, wherein said cyber shop information includes at least one of shop management information to manage each of a plurality of cyber shops in a form of a mall, shop layout information indicative of a layout in the cyber shop, electronic shopping cart electronic form information to display a list of goods selected by a customer, electronic shopping cart information in which information regarding the goods selected by the customer has been stored, and goods information in which information regarding the goods such as names, prices, and the like has been stored.

6. A system according to claim 4, wherein when a cyber shop is added by said cyber shop client, said cyber shop information forming means adds said cyber shop information on the basis of added cyber shop definition information.

7. A system according to claim 4, wherein when said cyber shop definition information is updated by said cyber shop client, said cyber shop information forming means updates said cyber shop information on the basis of updated cyber shop definition information.

8. A system according to claim 4, wherein when a cyber shop is deleted by said cyber shop client, said cyber shop information forming means deletes the cyber shop information corresponding to the deleted cyber shop.

9. A system according to claim 4, wherein said cyber shop defining means comprises:
shop layout information defining means for defining shop layout information of a layout in the cyber shop;
electronic shopping cart electronic form information defining means for defining electronic shopping cart electronic form information to display a list of goods selected by a customer; and
goods registering means for registering information regarding the goods such as names, prices, and the like.

10. A system according to claim 4, wherein said cyber shop information forming means comprises shop layout registering means, electronic shopping cart electronic form registering means, and goods storing means.

11. A system according to claim 4, wherein said shop layout defining means defines a layout of a goods arrangement in the cyber shop and a shop in a mall on the basis of shop layout information of a layout in the cyber shop, goods information in which information regarding the goods such as names, prices, and the like has been stored, and shop management information to manage the cyber shop in a form of mall.

12. A system according to claim 9, wherein said electronic shopping cart electronic form information defining means defines a form format of an electronic shopping cart electronic form to define the electronic shopping cart electronic form information to display a list of goods selected by the customer and a calculating equation to calculate a money amount of goods purchased.

13. A system according to claim 4, wherein said display information forming means comprises:
parameter analyzing means for analyzing a purchase request inputted from said customer client;
file retrieving means for retrieving necessary goods information on the basis of an analysis result; and
display data forming means for displaying a retrieval result.

14. A system according to claim 4, wherein said cyber mall server has mall information including any one of panel information and a program to manage a mall, customer information, and applying conditions to discount the goods.
